(19) United States
(12) Patent Application Publication
(10) Pub. No.: US 2026/0231002 A1
(43) Pub. Date: Aug. 6, 2026

(54) INFORMATION SENDING METHOD AND COMMUNICATION APPARATUS

(71) Applicant: BEIJING XIAOMI MOBILE SOFTWARE CO., LTD., Beijing (CN)

(72) Inventor: Yanhua LI, Beijing (CN)

(73) Assignee: BEIJING XIAOMI MOBILE SOFTWARE CO., LTD., Beijing (CN)

(21) Appl. No.: 19/153,986

(22) PCT Filed: Feb. 7, 2023
(86) PCT No.: PCT/CN2023/074854

§ 371 Date: Aug. 6, 2025

(51) Int. Cl. H04W 48/08

(52) U.S. Cl. CPC H04W 48/08

(57) ABSTRACT

A method for sending information, performed by a first communication node, includes: receiving delivery-related information of first information sent by a second communication node, in which the second communication node has sent a first part of the first information to a terminal; and sending the first information to the terminal based on the delivery-related information.

### CROSS-REFERENCE TO RELATED APPLICATIONS

The present application is a U.S. National Phase of International Application No. PCT/CN2023/074854, filed with the State Intellectual Property Office of P. R. China on Feb. 7, 2023, the content of which is incorporated herein by reference in its entirety for all purposes.

### TECHNICAL FIELD

The disclosure relates to the field of communication technologies, and in particular to methods for sending information and communication devices.

### BACKGROUND

In a communication network, the generation and the application of certain information may occur at different nodes. For example, the training and the reasoning of an artificial intelligence (AI) model may occur at different nodes, which requires delivering the AI model between nodes.

### SUMMARY

Embodiments of a first aspect of the disclosure provide a method for sending information, which is performed by a first communication node. The method includes receiving delivery-related information of first information sent by a second communication node; in which the second communication node has sent a first part of the first information to a terminal; and sending the first information to the terminal based on the delivery-related information.

Embodiments of a second aspect of the disclosure provide another method for sending information, which is performed by a first communication node. The method includes establishing a logical connection between the first communication node and a terminal; and sending first information to the terminal via the logical connection.

Embodiments of a third aspect of the disclosure provide another method for sending information, which is performed by a terminal, and the method includes: receiving first information, sent by a first communication node via a logical connection.

### BRIEF DESCRIPTION OF THE DRAWINGS

In order to more clearly illustrate the technical solutions in the embodiments of the disclosure or the background art, the drawings required for use in the embodiments of the disclosure or the background art will be described below.

FIG. 1 is a schematic diagram illustrating an architecture of a communication system according to an embodiment of the disclosure.

FIG. 2 is a schematic flowchart illustrating a method for sending information according to an embodiment of the disclosure.

FIG. 3 is a schematic flowchart illustrating another method for sending information according to an embodiment of the disclosure.

FIG. 4 is a schematic flowchart illustrating another method for sending information according to an embodiment of the disclosure.

FIG. 5 is a schematic flowchart illustrating another method for sending information according to an embodiment of the disclosure.

FIG. 6 is a schematic flowchart illustrating another method for sending information according to an embodiment of the disclosure.

FIG. 7 is a schematic flowchart illustrating another method for sending information according to an embodiment of the disclosure.

FIG. 8 is a schematic flowchart illustrating another method for sending information according to an embodiment of the disclosure.

FIG. 9 is a schematic flowchart illustrating another method for sending information according to an embodiment of the disclosure.

FIG. 10 is a schematic flowchart illustrating another method for sending information according to an embodiment of the disclosure.

FIG. 11 is a schematic flowchart illustrating another method for sending information according to an embodiment of the disclosure.

FIG. 12 is a schematic flowchart illustrating another method for sending information according to an embodiment of the disclosure.

FIG. 13 is a first schematic diagram illustrating a process of sending an AI according to an embodiment of the disclosure.

FIG. 14 is a second schematic diagram illustrating a process of sending an AI according to an embodiment of the disclosure.

FIG. 15 is a third schematic diagram illustrating a process of sending an AI according to an embodiment of the disclosure.

FIG. 16 is a schematic diagram illustrating a structure of a communication device according to an embodiment of the disclosure.

FIG. 17 is a schematic diagram illustrating a structure of a communication device according to an embodiment of the disclosure.

FIG. 18 is a schematic diagram illustrating a structure of a chip according to an embodiment of the disclosure.

### DETAILED DESCRIPTION

In order to better understand the methods for sending information according to the embodiments of the disclosure, the communication system to which the embodiments of the disclosure are applicable is first described below.

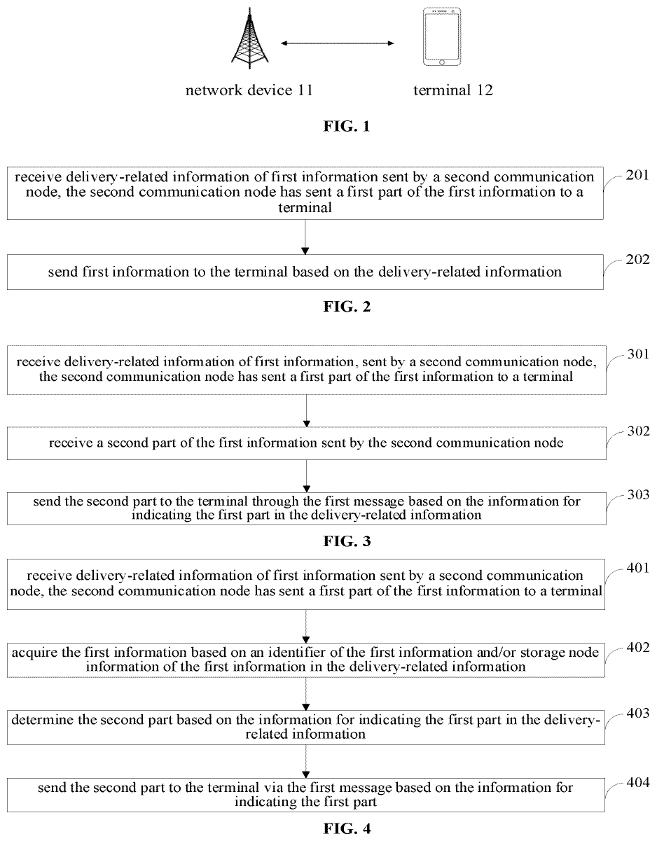

FIG. 1 is a schematic diagram illustrating an architecture of a communication system according to an embodiment of the disclosure. The communication system may include, but is not limited to, one network device and one terminal. The number and form of devices illustrated in FIG. 1 are only used as examples and do not constitute a limitation on the embodiments of the disclosure. In actual applications, two or more network devices and two or more terminals may be included. The communication system illustrated in FIG. 1 including one network device 11 and one terminal 12 is taken as an example.

It should be noted that the technical solutions of the embodiments of the disclosure may be applied to various communication systems, such as long term evolution (LTE) system, fifth generation (5G) mobile communication system, 5G new radio (NR) system, or other future new mobile communication systems.

The network device 11 in the embodiments of the disclosure is an entity on the network side for transmitting or receiving signals. For example, the network device 101 may be an evolved NodeB (eNB), a transmission reception point (TRP), a next generation NodeB (gNB) in an NR system, a base station in other future mobile communication systems, or an access node in a wireless fidelity (Wi-Fi) system. The embodiments of the disclosure do not limit the specific technology and specific device form adopted by the network device. The network device according to the embodiments of the disclosure may be composed of a central unit (CU) and distributed unit(s) (DU). The CU may also be referred to as a control unit. The used CU-DU structure may split the protocol layer of the network device, such as a base station, the functions of some protocol layers are placed in the CU for centralized control, and the functions of the remaining part or all of the protocol layers are distributed in the DU(s), and the DU(s) is/are centrally controlled by the CU.

The terminal 12 in the embodiments of the disclosure is an entity on the user side for receiving or transmitting signals, such as a mobile phone. The terminal may also be called terminal device, user equipment (UE), mobile station (MS), mobile terminal (MT), etc. The terminal may be a vehicle with communication function, a smart vehicle, a mobile phone, a wearable device, a tablet computer (Pad), a computer with wireless transceiver function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The embodiments of the disclosure do not limit the specific technology and specific device form adopted by the terminal.

It may be understood that the communication system described in the embodiments of the disclosure is for the purpose of more clearly illustrating the technical solution of the embodiments of the disclosure and does not constitute a limitation on the technical solution according to the embodiments of the disclosure. A person skilled in the art may know that with the evolution of the system architecture and the emergence of new business scenarios, the technical solution according to the embodiments of the disclosure is also applicable to similar technical problems.

In a communication network, the generation and the application of some information may occur at different nodes. For example, the training and the reasoning of an AI model may occur at different nodes, which requires delivering an AI model between nodes.

In a radio access network, the communication between a terminal and a base station may be performed via a control plane (CP) or a user plane (UP). However, due to the large number of AI models and the long delivery time, if the CP is used for delivery, switching occurs during the delivery process, the delivery of the AI model is interrupted, and the delivery cannot be completed. If the UP is used for delivery, the protocol in the related arts does not support data transmission initiated by the base station. That is, neither the UP nor the CP supports the delivery of the AI model. Therefore, how to send an AI model in a radio access network is an urgent problem to be solved.

In the disclosure, a first communication node may receive delivery-related information of the first information sent by the second communication node and send first information to the terminal based on the delivery-related information, thereby ensuring that the terminal receives the complete first information.

The methods for sending information and related communication devices according to the disclosure will be described in detail below with reference to the accompanying drawings.

FIG. 2 is a schematic flowchart illustrating a method for sending information according to an embodiment of the disclosure. The method is performed by a first communication node. As illustrated in FIG. 2, the method may include, but is not limited to, the following.

At step 201, delivery-related information of first information sent by a second communication node is received. The second communication node has sent a first part of the first information to a terminal.

In the disclosure, the first communication node and the second communication node may be access network devices (e.g., base stations, NG-RAN nodes, etc.). The first communication node may be a currently serving base station of the terminal. The second communication node may be a serving base station of the terminal before the first communication node. For example, base station 1 is a target base station in a handover process of the terminal, and base station 2 is a source base station in the handover process of the terminal. Or when base station 1 is serving the terminal, if the wireless environment of the terminal deteriorates and there is a need to handover to a base station with better service quality, the base station 1 hands over the terminal to base station 2, and then base station 2 serves the terminal.

In the embodiments of the disclosure, the delivery-related information of the first information may be included in an Xn application proposal (XnAP) message. The XnAP message may be a signaling transmission status message sent by a source base station to a target base station during a terminal handover process, or a radio resource control (RRC) transfer (RRC Transfer) message, etc.

In the disclosure, the first information may be an AI model, parameters of an AI model, or other information whose size exceeds a preset threshold, which is not limited in the disclosure.

In the disclosure, the first information may be in a format defined by the 3rd Generation Partnership Project (3GPP) or in a format defined by non-3GPP, such as a container.

In the disclosure, in the case that the second communication node decides to send the first information to the terminal, the first information may be sent to the terminal via multiple segmented messages based on the size of the first information and/or signaling transmission restrictions. For example, in the case that the first information is an AI model, the second communication node may send the AI model via 10 segmented messages.

When the terminal hands over from the second communication node to the first communication node, the second communication node has sent a part, namely the first part, of the first information to the terminal. The second communication node may send the delivery-related information of the first information to the first communication node, and the first communication node may receive the delivery-related information of the first information sent by the second communication node.

The delivery-related information of the first information may include, but is not limited to, an identifier of the first information, storage node information of the first information, information for indicating the first part, etc. For example, the second communication node sends the first message to the terminal via segmented messages, and the information for indicating the first part may include segmentation information of the first information, a percentage of a part sent by the second communication node to the first information, etc.

Here, the storage node information of the first information may be understood as information of a node storing the first information. The storage node information may be an identifier of a core network node, server address information, a base station identifier, a cell identifier, etc.

At step 202, first information is sent to the terminal based on the delivery-related information.

In the disclosure, the first communication node may obtain the first information based on the identifier of the first information or the storage node information of the first information in the delivery-related information and send the complete first information to the terminal. Or the first communication node may send the remaining part of the first information except the first part to the terminal based on the information for indicating the first part in the delivery-related information. Thus, it may be ensured that the terminal receives the complete first information.

In the embodiments of the disclosure, the first communication node may receive the delivery-related information of the first information sent by the second communication node and send the first information to the terminal based on the delivery-related information, thereby ensuring that the terminal receives the complete first information.

FIG. 3 is a schematic flowchart illustrating another method for sending information according to an embodiment of the disclosure. The method is performed by the first communication node. As illustrated in FIG. 3, the method may include, but is not limited to, the following.

At step 301, delivery-related information of first information sent by a second communication node is received. The second communication node has sent a first part of the first information to a terminal.

In the disclosure, step 301 may be implemented in any way of the embodiments of the disclosure, which is not described in detail here.

At step 302, a second part of the first information sent by the second communication node is received.

In the disclosure, when the terminal hands over from the second communication node to the first communication node, the second communication node has already sent a part, namely the first part, of the first information to the terminal. The second communication node may send the second part of the first information to the first communication node, and the first communication node may then receive the second part of the first information sent by the second communication node.

In the disclosure, the second part may be the remaining part of the first information except the first part, the second part may include some sent parts and the remaining part except the first part (for example, some sent parts may be parts, that the terminal did not receive correctly or it is unsure whether they are received correctly, of the first part), or the second part may be parts, that the terminal did not receive correctly, of the first part and the remaining part except the first part. The above is not limited in the disclosure.

In the disclosure, the explanations on the first communication node, the second communication node and the first information may be found in the above embodiments, which are not repeated here.

It should be noted that it is possible that step 301 is performed first and then step 302 is performed, it is also possible that step 302 is performed first and then step 301 is performed, or it is also possible that step 301 and step 302 are performed simultaneously. The disclosure does not limit the execution order of step 301 and step 302.

At step 303, the second part is sent to the terminal via the first message based on the information for indicating the first part in the delivery-related information.

In the disclosure, the delivery-related information of the first information may include the information for indicating the first part. The information for indicating the first part may include at least one of: segmentation information of the first information; segment number(s) of segmented message(s) of the first part; segment number(s) of segmented message(s) confirmed to have been received by the terminal; a recommended segment number of a second part; or a percentage of the first part in the first information.

The segmentation information of the first information may be understood as a total number of segmented messages used by the second communication node to send the first information. For example, the second communication node determines to send the AI model to the terminal via 8 segmented messages. That is, the segmentation information of the AI model is 8.

The segment number(s) of the segmented message(s) of the first part may be understood as the segment number(s) of the segmented message(s) used by the second communication node to send the first part. In an instance, the second communication node sends an AI model via the segmented messages. For example, the second communication node sends the segmented messages with the segment numbers, namely 0, 1, 2, and 3, to the terminal. That is, the segment numbers of the segmented messages sent by the second communication node are 0, 1, 2, and 3.

The segment number(s) of the segmented message(s) confirmed to have been received by the terminal may be understood as the segment number(s) of the segmented message(s) of a part, in the first part, confirmed to have been received by the terminal. For example, the second communication node sends the segmented messages with the segment numbers, namely 0, 1, 2, and 3, to the terminal and the segmented messages confirmed to have been received by the terminal are segmented messages with segment numbers 0, 1 and 3. That is, the segment numbers of the segmented messages confirmed to have been received by the terminal are 0, 1 and 3.

The recommended segment number of the second part may be understood as a segment number of a first segmented message that the second communication node recommends the first communication node to send, or a next segment number of the segment number of the segmented message sent by the second communication node. For example, the second communication node determines to send an AI model to the terminal via 10 segmented messages and the second communication node has sent 6 segmented messages with the segment numbers 0 to 5 to the terminal, then the recommended segment number of the second part may be 6.

The percentage of the first part in the first information may be understood as how much of the first information has been sent to the terminal by the second communication node. The first communication node may determine the content of the second part to be sent based on the percentage of the first part in the first information.

In the disclosure, the first communication node may send the second part to the terminal via the first message based on the information for indicating the first part in the delivery-related information. The first message may be a single message or may be sent in segments. That is, the second part may be sent via multiple segmented messages.

In the disclosure, the first message may be any one of: a radio resource control (RRC) message, a non-access stratum (NAS) message, or a newly defined protocol message. For example, the first information is an AI model, and the newly defined protocol message may be a protocol message supporting an AI function and/or a protocol message transmitting an AI model.

For example, in a case that the information for indicating the first part includes the segment number(s) of the segmented message(s) of the first part, the first communication node may add a segment number to a segmented message used to send the remaining part, based on the segment number(s) of the segmented message(s) of the first part, and then send the second part to the terminal via the segmented message(s), so that the terminal may reassemble different segmented messages to obtain the complete first information.

As another example, in a case that the information for indicating the first part includes the segment number(s) of the segmented message(s) of the first part and the segment number(s) of the segmented message(s) confirmed to have been received by the terminal, the first communication node may determine segment number(s) of segmented message(s) of a part, in the first part, that the terminal has not correctly received, based on the segment number(s) of the segmented message(s) of the first part and the segment number(s) of the segmented message(s) confirmed to have been received by the terminal. Further, the terminal may add segment number(s) to segmented message(s) used to send the remaining part based on the segment number(s) of the segmented message(s) of the first part, and then send the part, in the first part, that the terminal has not correctly received and the remaining part of the first information except the first part to the terminal via the segmented messages, such that the terminal may reorganize the segmented messages to obtain the complete first information.

In the embodiment of the disclosure, the first communication node may receive the delivery-related information of the first information sent by the second communication node, receive the second part of the first information sent by the second communication node, and send the second part to the terminal via the first message based on the information for indicating the first part in the delivery-related information. Thus, in the case that the terminal hands over from the second communication node to the first communication node, the first communication node may send the second part received from the second communication node to the terminal based on the delivery-related information of the first information, thereby ensuring that the terminal receives the complete first information.

FIG. 4 is a schematic flowchart illustrating another method for sending information according to an embodiment of the disclosure. The method is performed by the first communication node. As illustrated in FIG. 4, the method may include, but is not limited to, the following.

At step 401, delivery-related information of first information sent by a second communication node is received. The second communication node has sent a first part of the first information to a terminal.

In the disclosure, step 401 may be implemented in any way of the embodiments of the disclosure, which is not described in detail here.

At step 402, the first information is acquired based on an identifier of the first information and/or storage node information of the first information in the delivery-related information.

In the disclosure, the delivery-related information of the first information may include the identifier of the first information and/or the storage node information of the first information. For the storage node information of the first information, reference may be made to the above embodiments, and the storage node information is not described in detail here.

In the disclosure, the first communication node may obtain the first information based on the identifier of the first information. Or the first communication node may include the identifier of the first information in the first message sent to the terminal to instruct the terminal to reassemble the received messages to obtain the first information.

The first communication node may also obtain the first information from a node indicated by the storage node information based on the storage node information of the first information. Or the first communication node may also obtain the first information based on the identifier of the first information and the storage node information of the first information.

At step 403, the second part is determined based on the information for indicating the first part in the delivery-related information.

In the disclosure, the delivery-related information may also include the information for indicating the first part. For explanations of the information for indicating the first part, reference may be made to the above embodiments and the information for indicating the first part will not be described in detail here.

In the disclosure, after acquiring the first information, the first communication node may determine the second part based on the information for indicating the first part. For explanations of the second part, reference may be made to the above embodiments and the second part will not be described in detail here.

For example, the information for indicating the first part includes the segment number(s) of the segmented message(s) of the first part. Then the first communication node determines the remaining part of the first information except the first part based on the segment number(s) of the segmented message(s) of the first part and determines the remaining part as the second part.

As another example, the information for indicating the first part includes the segment number(s) of the segmented message(s) of the first part and the segment number(s) of the segmented message(s) confirmed to have been received by the terminal. Then, the first communication node may determine the segment number(s) of the remaining part of the first information except the first part and the segment number(s) of the segmented message(s) not correctly received by the terminal based on the segment number(s) of the segmented message(s) of the first part, and may determine the remaining part and the part not correctly received by the terminal as the second part.

As another example, the information for indicating the first part includes the recommended segment number of the second part, and the first communication node may determine the segment number(s) of the segmented message(s) transmitted by the second communication node based on the recommended segment number of the second part or the first communication node may determine the remaining part of the first information except the first part and use the remaining part as the second part.

At step 404, the second part is sent to the terminal via the first message based on the information for indicating the first part.

In the disclosure, step 404 may be implemented in any way of the embodiments of the disclosure and will not be described in detail here.

In the embodiments of the disclosure, the first communication node may receive the delivery-related information of the first information sent by the second communication node, obtain the first information based on the identifier of the first information and/or the storage node information of the first information in the delivery-related information, determine the second part based on the information for indicating the first part in the delivery-related information, and send the second part to the terminal via the first message. Thus, when the terminal performs a handover from the second communication node to the first communication node, the first communication node may determine the second part of the first information based on the delivery-related information of the first information and send the second part to the terminal, thereby ensuring that the terminal receives the complete first information.

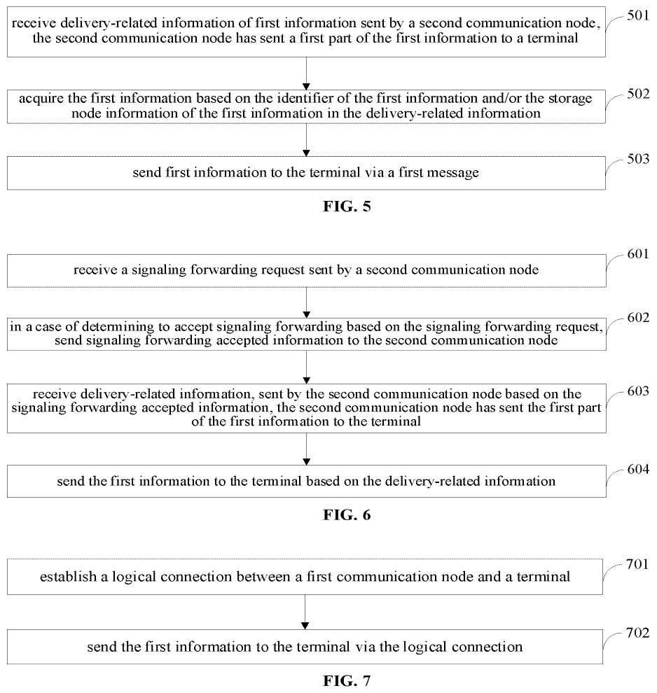

FIG. 5 is a schematic flowchart illustrating another method for sending information according to an embodiment of the disclosure. The method is performed by the first communication node. As illustrated in FIG. 5, the method may include, but is not limited to, the following.

At step 501, delivery-related information of first information sent by a second communication node is received. The second communication node has sent a first part of the first information to a terminal.

At step 502, the first information is obtained based on the identifier of the first information and/or the storage node information of the first information in the delivery-related information.

In the disclosure, step 501 to step 502 may be implemented in any way of the embodiments of the disclosure and will not be described in detail herein.

At step 503, first information is sent to the terminal via a first message.

In the disclosure, the first communication node may send the acquired complete first information to the terminal via a first message. The first message may be a single message or may be sent in segments. That is, the first information is sent to the terminal via multiple segmented messages, which is not limited in the disclosure.

In the embodiments of the disclosure, the first communication node may receive the delivery-related information of the first information sent by a second communication node, obtain the first information based on the identifier of the first information and/or the storage node information of the first information in the delivery-related information, and send the complete first information to the terminal via the first message, thereby ensuring that the terminal receives the complete first information.

FIG. 6 is a schematic flowchart illustrating another method for sending information according to an embodiment of the disclosure. The method is performed by a first communication node. As illustrated in FIG. 6, the method may include, but is not limited to, the following.

At step 601, a signaling forwarding request sent by a second communication node is received.

In the disclosure, when a terminal hands over from a second communication node to a first communication node, in order to ensure that the terminal may receive the complete first information, the second communication node may send the signaling forwarding request to the first communication node, and the first communication node may receive the signaling forwarding request sent by the second communication node.

In the embodiments of the disclosure, the signaling forwarding request may be included in an XnAP message. The XnAP message may be a handover request message sent by a source base station to a target base station in a handover process of the terminal. The source base station is the second communication node, and the target base station is the first communication node.

In the disclosure, the signaling forwarding request may be information for indicating a signaling forwarding requirement, and the signaling forwarding request may include, but is not limited to, a size of the remaining part of the first information except the first part, segmentation requirement indication information, or the like. Here, the segmentation requirement indication information may be understood as an indication that the first information needs to be sent using segmented messages.

At step 602, in a case of determining to accept signaling forwarding based on the signaling forwarding request, signaling forwarding accepted information is sent to the second communication node.

In the disclosure, the first communication node determines whether to accept the signaling forwarding based on the signaling forwarding request, that is whether to send information indicating that the signaling forwarding is accepted, i.e., the signaling forwarding accepted information, to the second communication node. In the case that the first communication node determines to accept the signaling forwarding based on the signaling forwarding request, the first communication node may send the signaling forwarding accepted information to the second communication node to indicate that the signaling forwarding is accepted.

In the embodiments of the disclosure, the signaling forwarding accepted information may be included in an XnAP message. The XnAP message may be a handover request confirmation message sent by the target base station to the source base station in the handover process of the terminal. The source base station is the second communication node, and the target base station is the first communication node.

At step 603, delivery-related information sent by the second communication node based on the signaling forwarding accepted information is received. The second communication node has sent the first part of the first information to the terminal.

In the disclosure, after receiving the signaling forwarding accepted information sent by the first communication node, the second communication node may send the delivery-related information of the first information to the first communication node.

In the disclosure, for explanations of the first information and the delivery-related information of the first information, reference may be made to the above embodiments, and they will not be repeated here.

At step 604, the first information is sent to the terminal based on the delivery-related information.

In the disclosure, step 604 may be implemented in any way of the embodiments of the disclosure, which will not be described in detail here.

In the embodiments of the disclosure, the first communication node may receive the signaling forwarding request sent by the second communication node. When the first communication node determines to accept the signaling forwarding based on the signaling forwarding request sent by the second communication node, the first communication node may send the signaling forwarding accepted information to the second communication node, receive the delivery-related information of the first information sent by the second communication node, and send the first information to the terminal based on the delivery-related information. Thus, it is possible to ensure that the terminal receives the complete first information by increasing the signaling forwarding.

FIG. 7 is a schematic flowchart illustrating another method for sending information according to an embodiment of the disclosure. The method is performed by the first communication node. As illustrated in FIG. 7, the method may include, but is not limited to, the following.

At step 701, a logical connection between a first communication node and a terminal is established.

In the disclosure, the first communication node may establish the logical connection between the first communication node and the terminal. The logical connection may be, but is not limited to, a logical channel, a bearer, a data radio bearer (DRB), a quality of service flow (QOS flow) and/or a protocol data unit (PDU) session.

In the disclosure, the first communication node may be an access network device (e.g., a base station, an NG-RAN node, or the like), may be a DU of an access network device, or may be a UP of a CU of an access network device.

At step 702, the first information is sent to the terminal via the logical connection.

In the disclosure, the first communication node may send the first information to the terminal via the logical connection.

In the embodiments of the disclosure, the first communication node may establish the logical connection between the first communication node and the terminal and send the first information to the terminal via the logical connection, thereby enabling to send the first information from the first communication node to the terminal.

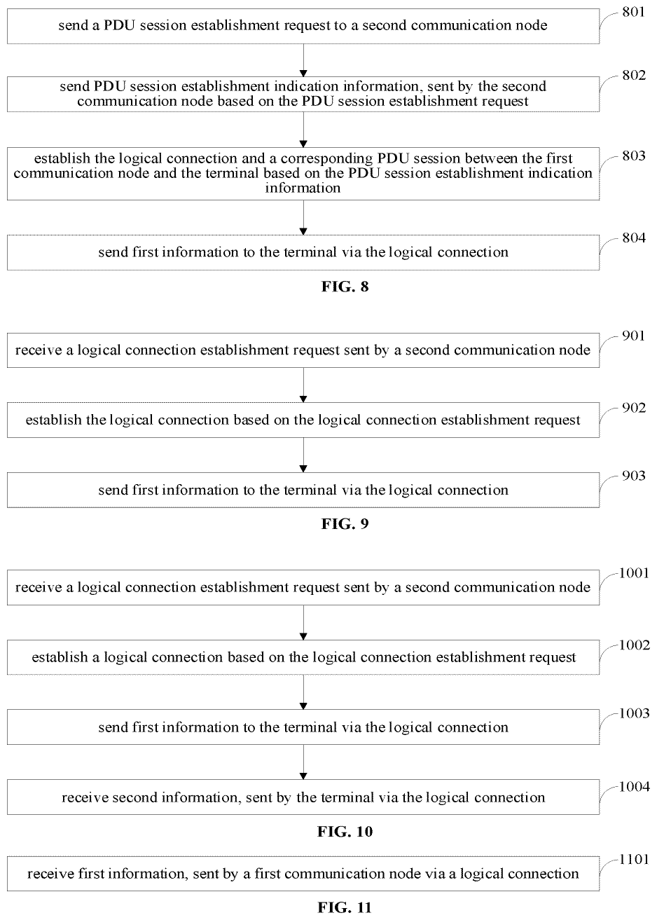

FIG. 8 is a schematic flowchart illustrating another method for sending information according to an embodiment of the disclosure. The method is performed by the first communication node. As illustrated in FIG. 8, the method may include, but is not limited to, the following.

At step 801, a PDU session establishment request is sent to a second communication node.

In the disclosure, the first communication node may be an access network device (e.g., a base station, an NG-RAN node, or the like), and the second communication node may be a core network device, such as a session management function (SMF) or an access and mobility management function (AMF), etc.

In the embodiments of the disclosure, the PDU session establishment request may be included in an NGAP message sent by the NG-RAN node to the AMF. The NGAP message may be a PDU session establishment request message or a PDU session establishment indication message, etc.

In the disclosure, in the case that the first communication node decides to send the first information to the terminal, the first communication node may send the PDU session establishment request to the second communication node. The PDU session establishment request may include at least one of: a PDU session request indication; a QoS requirement of the PDU session; a duration of the PDU session; an identifier of the first information; a data size of the first information, or the like.

In some examples, the QoS requirement of the PDU session may include, but are not limited to, bandwidth, latency, or a bit error rate requirement.

In some examples, the duration of the PDU session may indicate a usage duration of the requested PDU session.

In some examples, the identifier of the first information may indicate the content of the first information, which may be used for QoS policy management and/or billing.

In some examples, the data size of the first information may be used for QoS policy management and/or billing.

At step 802, PDU session establishment indication information sent by the second communication node based on the PDU session establishment request is received.

In the disclosure, after receiving the PDU session establishment request from the first communication node, the second communication node may initiate a PDU session resource establishment process based on the PDU session establishment request, including PDU session establishment indication information. The PDU session establishment indication information may include indication information for indicating that the PDU session to be established is used to send the first information, such as a radio access network triggered indication (RAN triggered indication).

In the embodiments of the disclosure, the PDU session establishment request may be included in an NGAP message sent by the AMF to the NG-RAN node, in which the NGAP message may be related to PDU session resource establishment or modification.

At step 803, the logical connection and a corresponding PDU session between the first communication node and the terminal are established based on the PDU session establishment indication information.

In the disclosure, the first communication node may establish the PDU session for sending the first information and the corresponding logical connection between the first communication node and the terminal based on the indication information, in the PDU session establishment indication information, for indicating that the PDU session to be established is used to send the first information.

At step 804, first information is sent to the terminal via the logical connection.

In the disclosure, the first communication node may send the first information to the terminal via the logical connection.

In some examples, in sending by the first communication node the first information to the terminal via the logical connection, the first information may be included in a packet data convergence protocol service data unit (PDCP SDU) or a service data adaptation protocol service data unit (SDAP SDU) for transmission.

In some examples, the PDCP SDU for transmitting the first information may also include auxiliary information, and it becomes a PDCP PDU after being processed by the protocol layer. That is, the PDCP PDU includes the PDCP SDU and the auxiliary information. The auxiliary information may be used to instruct the terminal to receive and process the first information.

In some examples, the SDAP SDU for transmitting the first information may also include auxiliary information, and it becomes an SDAP PDU after being processed by the protocol layer. That is, the SDAP PDU includes the SDAP SDU and the auxiliary information. The auxiliary information may be used to instruct the terminal to receive and process the first information.

In some embodiments, the auxiliary information may indicate a type or a purpose of the first information such that the terminal receives and processes the PDCP PDU or the SDAP PDU including the first information based on the type or the purpose of the first information.

In the embodiments of the disclosure, the first communication node may be an access network device and the second communication node may be a core network device. The first communication node may send a PDU session establishment request to the second communication node, receive PDU session establishment indication information sent by the second communication node based on the PDU session establishment request, establish the PDU session and the corresponding logical connection based on the PDU session establishment indication information, and send the first message to the terminal via the logical connection. Thus, when the access network device sends the first message to the terminal, the access network device may initiate a PDU session establishment and establish the logical connection through the core network device, and send the first message via the logical connection, such that the access network device may initiate the sending of the first message and send the first message to the terminal.

FIG. 9 is a schematic flowchart illustrating another method for sending information according to an embodiment of the disclosure. The method is performed by the first communication node. As illustrated in FIG. 9, the method may include, but is not limited to, the following.

At step 901, a logical connection establishment request sent by a second communication node is received.

In the disclosure, the first communication node may be a DU of an access network device, the second communication node may be a CU of the access network device, the bearer establishment request may be included in an F1 application protocol (F1AP) message. The F1AP message may be a terminal context establishment request message and/or a terminal context modification request message. Or the first communication node may be a UP of a CU of an access network device, the second communication node may be a CP of the CU of the access network device, the bearer establishment request may be included in an E1 application protocol (E1AP) message. The E1AP message may be a bearer context establishment request message and/or a bearer context modification request message.

In the disclosure, the second communication node may send a logical connection establishment request to the first communication node, and the first communication node may receive the logical connection establishment request sent by the first communication node. The logical connection establishment request may be a request for establishing the logical connection.

In the disclosure, the logical connection establishment request may include at least one of: an identifier of the logical connection; a reason for establishing the logical connection; or a QoS requirement of the logical connection.

In some examples, the identifier of the logical connection may be an identifier related to the first information. For example, in the case that the first information is an AI model and the logical connection is a DRB, the identifier of the logical connection may be an AI DRB identifier or a DRB identifier with an AI indication.

In some examples, the reason for establishing the logical connection may be transmitting the first information.

In some examples, the QoS requirement of the logical connection may be used to instruct the first communication node to allocate resources based on the QoS requirement of the logical connection.

At step 902, the logical connection is established based on the logical connection establishment request.

In the disclosure, the first communication node may establish the logical connection based on the logical connection establishment request. For explanations of the logical connection, reference may be made to the above embodiments, which will not be repeated here.

In the disclosure, the logical connection may not have a corresponding PDU session, or a logical connection may correspond to a dummy PDU session.

In the disclosure, in the case that the PDU session establishment list information does not include the logical connection establishment request, the first communication node may establish the logical connection based on the logical establishment request, and the established logical connection here does not have a corresponding PDU session.

In the case that the PDU session establishment list information includes the logical connection establishment request, the logical connection establishment request may include dummy PDU session indication information, and the first communication node may establish the logical connection based on the logical connection establishment request. The established logical connection here corresponds to a dummy PDU session and is only used for the access network side. Thus, the access network device may initiate the establishment of the dummy PDU session without involving the core network device.

At step 903, first information is sent to the terminal via the logical connection.

In the disclosure, step 903 may be implemented in any way of the embodiments of the disclosure, which will not be described in detail here.

In the disclosure, the first information may be generated by the first communication node itself or may be sent by the second communication node to the first communication node, which is not limited in the disclosure.

In the embodiments of the disclosure, the first communication node may receive the logical connection establishment request sent by the second communication node, establish the logical connection based on the logical connection establishment request, and send the first information to the terminal via the logical connection, thereby enabling the access network device to initiate the sending of the first information and send the first message to the terminal.

FIG. 10 is a schematic flowchart illustrating another method for sending information according to an embodiment of the disclosure. The method is performed by the first communication node. As illustrated in FIG. 10, the method may include, but is not limited to, the following.

At step 1001, a logical connection establishment request sent by a second communication node is received.

At step 1002, a logical connection is established based on the logical connection establishment request.

At step 1003, first information is sent to the terminal via the logical connection.

In the disclosure, steps 1001 to 1003 may be implemented in any way of the embodiments of the disclosure, and will not be described in detail herein.

At step 1004, second information sent by the terminal via the logical connection is received.

In the disclosure, the terminal may also transmit second information to the first communication node via the logical connection, and the first communication node may then receive the second information sent by the terminal via the logical connection.

The second information may be an AI model or may be information whose size is greater than a preset threshold. The second information may be different from the first information.

In the embodiment of the disclosure, the first communication node may receive the logical connection establishment request sent by the second communication node, establish the logical connection based on the logical connection establishment request, send the first information to the terminal via the logical connection, and receive the second information sent by the terminal via the logical connection. Thus, not only may the access network device initiate the sending of the first information, but also the terminal may initiate the sending of the second information.

FIG. 11 is a schematic flowchart illustrating another method for sending information according to an embodiment of the disclosure. The method is performed by a terminal. As illustrated in FIG. 11, the method may include, but is not limited to, the following.

At step 1101, first information sent by a first communication node via a logical connection is received.

In the disclosure, the logical connection is established between the first communication node and the terminal. The first communication node may send the first information to the terminal, and the terminal may receive the first information, sent by the first communication node via the logical connection. The first information may be generated by the first communication node itself or received from the second communication node, which is not limited in the disclosure.

In some examples, the terminal may receive first information, sent by the first communication node via the logical connection, in which the first information may be included in a PDCP SDU or a SDAP SDU and sent to the terminal.

In some examples, the PDCP SDU for transmitting the first information may also include auxiliary information, and it becomes a PDCP PDU after being processed by the protocol layer. That is, the PDCP PDU includes the PDCP SDU and the auxiliary information. The auxiliary information may be used to instruct the terminal to receive and process the first information.

In some examples, the SDAP SDU for transmitting the first information may also include auxiliary information, and it becomes an SDAP PDU after being processed by the protocol layer. That is, the SDAP PDU includes the SDAP SDU and the auxiliary information. The auxiliary information may be used to instruct the terminal to receive and process the first information.

In some embodiments, the auxiliary information may indicate a type or a purpose of the first information such that the terminal receives and processes the PDCP PDU or SDAP PDU including the first information based on the type or the purpose of the first information.

In the disclosure, the first communication node may be a DU of an access network device and the second communication node may be a CU of the access network device, or the first communication node may be a UP of a CU of an access network device and the second communication node may be a CP of the CU of the access network device.

In the embodiments of the disclosure, the terminal may receive the first information sent by the first communication node via the logical connection, such that the terminal may receive the first information sent by the first communication node.

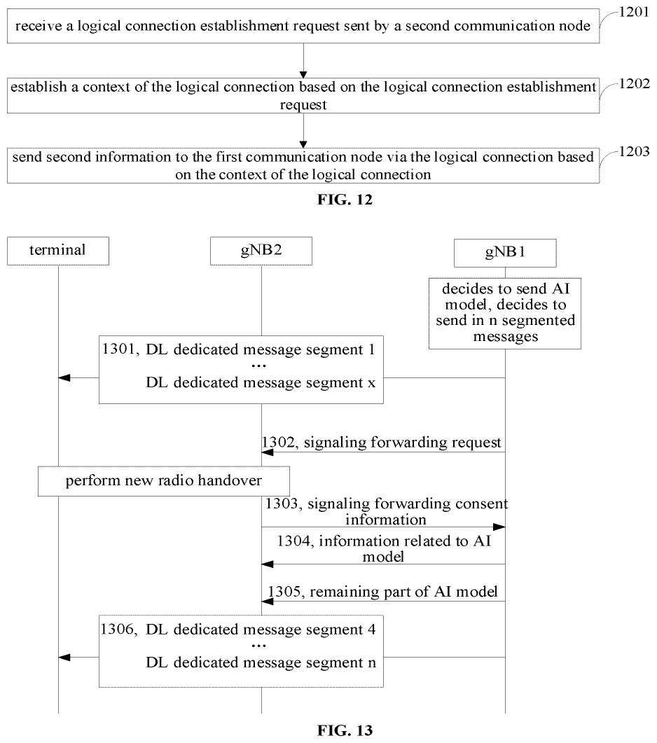

FIG. 12 is a schematic flowchart illustrating another method for sending information according to an embodiment of the disclosure. The method is performed by a terminal. As illustrated in FIG. 12, the method may include, but is not limited to, the following.

At step 1201, a logical connection establishment request sent by a second communication node is received.

In the disclosure, the second communication node may send the logical connection establishment request to the first communication node to instruct the first communication node to establish the logical connection between the first communication node and the terminal. The second communication node may also send the logical connection establishment request to the terminal, and the terminal may then receive the logical connection establishment request sent by the second communication node.

In the disclosure, the logical connection establishment request may include at least one of: an identifier of the logical connection, a reason for establishing the logical connection, or a QoS requirement of the logical connection.

At step 1202, a context of the logical connection is established based on the logical connection establishment request.

In the disclosure, the terminal may receive the logical connection establishment request.

In the disclosure, the terminal may establish the terminal-side context of the logical connection based on logical connection establishment request.

At step 1203, second information is sent to the first communication node via the logical connection based on the context of the logical connection.

In the disclosure, the terminal may send the second information to the first communication node via the logical connection based on the context of the logical connection, such that the terminal may transmit the second information to the first communication node.

For example, in the case that the second information is an AI model, the terminal may transmit the AI model to the first communication node based on the logical connection between the terminal and the first communication node.

In the disclosure, for explanations of the logical connection, reference may be made to the above embodiments, which will not be repeated here.

In the embodiments of the disclosure, the terminal may receive the logical connection establishment request sent by the second communication node, establish the context of the logical connection based on the logical connection establishment request, and may send the second information to the first communication node via the logical connection based on the context of the logical connection. Thus, the terminal may transmit the second information to the first communication node via the logical connection between the terminal and the first communication node based on the context of the logical connection.

In order to facilitate understanding of the methods for sending information according to the embodiments of the disclosure, the following is an example in which the first information is an AI model, the first communication node is gNB2, and the second communication node is gNB2, and is described in conjunction with FIG. 13. FIG. 13 is a first schematic diagram illustrating an AI sending process according to an embodiment of the disclosure.

In FIG. 13, at step 1301, gNB1 decides to send the AI model to the terminal. Based on the size of the AI model and/or the signaling transmission restrictions, gNB1 decides to divide the AI model to be transmitted into n segments and send it to the terminal via downlink dedicated message segment (DL Dedicated Message Segment) messages. Before the terminal performs the handover, the first segment to the x^{th} segment have been sent, where x is less than n.

At step 1302, gNB1 decides to hand over the terminal to gNB2 (for example, when the wireless environment of the terminal deteriorates and there is a need to hand over to a base station with better service quality). The gNB1 sends a signaling forwarding request to the gNB2. Information of the signaling forwarding request may be included in a handover request message sent by the gNB1 to the gNB2.

At step 1303, the gNB2 receives the signaling forwarding request and decides whether to accept signaling forwarding based on the signaling forwarding request. In the case that the gNB agrees to forward the signaling, gNB2 sends a signaling forwarding accepted information to gNB1 to indicate that the signaling forwarding is accepted. The signaling forwarding accepted information may be included in a handover request confirmation message sent by gNB2 to gNB1.

At step 1304, gNB1 sends delivery-related information of the AI model to gNB2.

At step 1305, gNB1 sends the remaining part of the AI model to gNB2.

At step 1306, gNB2 sends segmented message(s) of the remaining part to the terminal based on the delivery-related information of the AI model. That is, the gNB2 sends downlink dedicated message segment (DL Dedicated Message Segment) message(s) to the terminal, such as from the segment (x+1) to the segment n.

The terminal receives the segmented messages and reassembles the segments based on the segmented messages to obtain the complete AI model.

It should be noted that the execution order of the above steps 1304 and 1305 is not limited.

To facilitate understanding of the methods for sending information according to the embodiments of the disclosure, the following is an example where the first information is an AI model, the first communication node is a gNB, the second communication node is a core network device, and the logical connection is a DRB, and is described in conjunction with FIG. 14. FIG. 14 is a second schematic diagram illustrating an AI sending process according to an embodiment of the disclosure.

In FIG. 14, at step 1401, in a case that the gNB (i.e., base station) serving the terminal decides to transmit the AI model to the terminal, the gNB sends a PDU session establishment request to the core network device (such as AMF or SMF, etc.).

At step 1402, the core network device decides to establish a PDU session based on the PDU session establishment request. The core network device sends PDU session establishment indication information to the gNB. The PDU session establishment indication information may include the reason for the PDU session request (e.g., RAN Triggered indication). The gNB establishes the PDU session and the DRB with the terminal based on the reason.

At step 1403, the gNB sends a PDU session establishment response to the core network device.

At step 1404, after the establishment of the PDU session is finished, the gNB sends the AI model to the terminal via the DRB corresponding to the PDU session.

In some examples, the AI model may be included in the PDCP SDU or SDAP SDU, and the gNB includes auxiliary information in the PDCP or SDAP packet header. The auxiliary information may be used to instruct a terminal access stratum (AS) to receive and process the PDCP SDU. For example, the PDCP SDU is used for that information transmission initiated by the radio access network (RAN) or the content of the delivery is the AI model, and the terminal AS sends the received AI model to the corresponding processing unit (such as the AI processing unit).

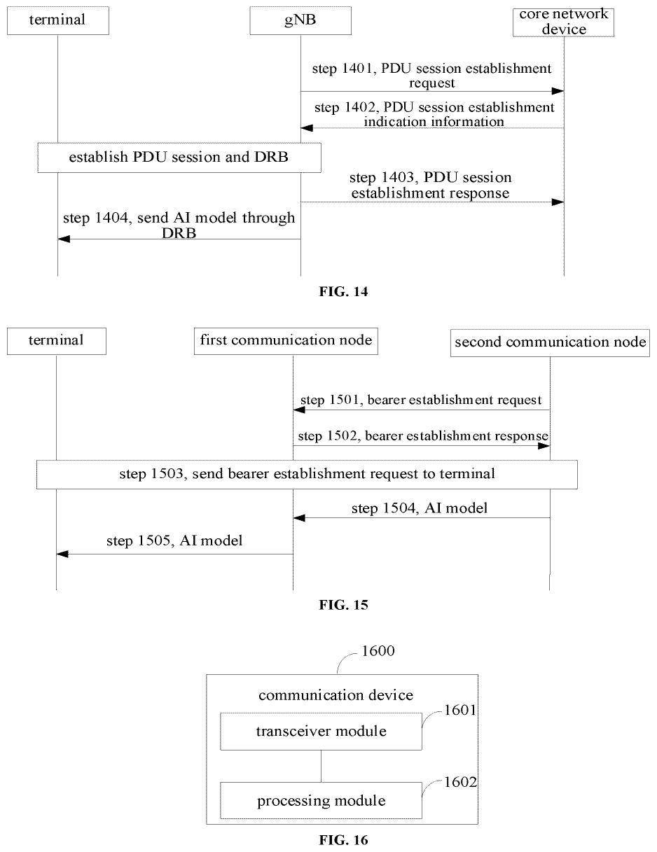

To facilitate understanding of the methods for sending information according to the embodiments of the disclosure, the following is an example where the first information is an AI model and the logical connection is a bearer, and is described in conjunction with FIG. 15. FIG. 15 is a third schematic diagram illustrating an AI sending process according to an embodiment of the disclosure.

In FIG. 15, at step 1501, the second communication node sends a bearer establishment request to the first communication node. The bearer has no corresponding PDU session, or the bearer corresponds to a dummy PDU session. In some examples, the bearer establishment request may include a bearer identifier, a reason for establishing the bearer and/or a QoS requirement.

At step 1502, the first communication node establishes a bearer based on the bearer establishment request and sends a bearer establishment feedback, i.e., a bearer establishment response, to the second communication node.

There are following possible situations of the first communication node and the second communication node.

The first communication node is gNB-DU, the second communication node is gNB-CU, the bearer establishment request may be included in an F1AP message, and the F1AP message may be a terminal context establishment request message and/or a terminal context modification request message.

The first communication node is gNB-CU-UP, the second communication node is gNB-CU-CP, the bearer establishment request may be included in an E1AP message, and the E1AP message may be a bearer context establishment request message and/or a bearer context modification request message.

At step 1503, the second communication node sends the bearer establishment request to the terminal such that the terminal establishes a terminal-side bearer context. The bearer establishment request may include the content in step 1501.

At step 1504, the second communication node sends the AI model to the first communication node.

At step 1505, the first communication node sends the AI model to the terminal via the established bearer.

It should be noted that, in the disclosure, the term “based on” may also mean “according to” or “in consideration of”, which is not limited in the disclosure.

FIG. 16 is a schematic diagram illustrating a structure of a communication device according to an embodiment of the disclosure. The communication device 1600 illustrated in FIG. 16 may include a transceiver module 1601 and a processing module 1602. The transceiver module 1601 may include a sending module and/or a receiving module. The sending module is configured to implement a sending function. The receiving module is configured to implement a receiving function. The transceiver module 1601 may implement a sending function and/or a receiving function.

It is understandable that the communication device 1600 may be a first communication node, a device in the first communication node, or a device that may be used in conjunction with the first communication node. The first communication node may be an access network device, such as a base station.

The communication device 1600 is on the first communication node side.

The transceiver module 1601 is configured to receive delivery-related information of the first information sent by the second communication node. The second communication node has sent a first part of the first information to the terminal. The transceiver module 1601 is further configured to send the first information to the terminal based on the delivery-related information.

In some examples, the transceiver module 1601 is configured to receive a second part of the first information sent by the second communication node; and send the second part to the terminal via a first message based on information for indicating the first part in the delivery-related information.

In some examples, the transceiver module 1601 is configured to acquire the first information based on an identifier of the first information and/or storage node information of the first information in the delivery-related information; determine the second part based on the information for indicating the first part in the delivery-related information; and send the second part to the terminal via the first message based on the information for indicating the first part.

In some embodiments, the information for indicating the first part includes at least one of: segmentation information of the first information, segment number(s) of segmented message(s) of the first part, segment number(s) of segmented message(s) confirmed to have been received by the terminal, recommended segment number(s) of the second part; or a percentage of the first part in the first information.

In some embodiments, the transceiver module 1601 is configured to acquire the first information based on an identifier of the first information and/or storage node information of the first information in the delivery-related information; and send the first information to the terminal via the first message.

In some examples, the first message is sent in segments.

In some examples, the first message is any one of: an RRC message, an NAS messages, or a newly defined protocol message.

In some examples, receiving the delivery-related information of the first information sent by the second communication node includes: receiving a signaling forwarding request sent by the second communication node; in a case of determining to accept signaling forwarding based on the signaling forwarding request, sending signaling forwarding accepted information to the second communication node; and receiving the delivery-related information, sent by the second communication node based on the signaling forwarding accepted information.

In the disclosure, the first communication node may receive the delivery-related of the first information sent by the second communication node, and send the first information to the terminal based on the delivery-related information, thereby ensuring that the terminal receives the complete first information.

It is understandable that the communication device 1600 may be a first communication node, a device in the first communication node, or a device that may be used in conjunction with the first communication node. The first communication node may be an access network device (e.g., a base station, an NG-RAN node, or the like).

The communication device 1600 is on the first communication node side.

The processing module 1602 is configured to establish a logical connection between the first communication node and the terminal.

The transceiver module 1601 is configured to send first information to the terminal via the logical connection.

In some examples, the first communication node is an access network device, and the second communication node is a core network device. The processing module 1602 is configured to: send a protocol data unit (PDU) session establishment request to the second communication node; receive PDU session establishment indication information, sent by the second communication node based on the PDU session establishment request; in which the PDU session establishment indication information includes indication information for indicating that a PDU session to be established is used to send the first information; and establish the logical connection and the PDU session corresponding to the logical connection are established between the first communication node and the terminal based on the PDU session establishment indication information.

In some examples, the PDU session establishment request includes at least one of: PDU session request indication; a quality of service (QOS) requirement of the PDU session; a duration of the PDU session; an identifier of the first information; or a data size of the first information.

In some examples, the transceiver module 1601 is configured to send the first message to the terminal via the logical connection, in which the first message is included in a data convergence protocol service data unit (PDCP SDU) or a service data adaptation protocol service data unit (SDAP SDU).

In some examples, the PDCP SDU or SDAP SDU also includes auxiliary information, in which the auxiliary information is used for instructing the terminal to receive and process the first information.

In some examples, the transceiver module 1601 is configured to receive a logical connection establishment request sent by a second communication node; and establish the logical connection based on the logical connection establishment request.

In some examples, the transceiver module 1601 is configured to establish the logical connection based on the logical connection establishment request in a case that the logical connection establishment request is not included in the PDU session establishment list information; in which the logical connection has no corresponding PDU session.

In some examples, the transceiver module 1601 is configured to establish the logical connection based on the logical connection establishment request in a case that the PDU session establishment list information includes the logical connection establishment request, in which the logical connection establishment request includes dummy PDU session indication information, and the logical connection corresponds to a dummy PDU session.

In some examples, the first information is sent by the second communication node to the first communication node.

In some examples, the transceiver module 1601 is further configured to receive second information, sent by the terminal via the logical connection.

In some examples, the logical connection establishment request includes at least one of: an identifier of the logical connection, a reason for establishing the logical connection, or a quality of service (QOS) requirement of the logical connection.

In some examples, the first communication node is a distributed unit (DU) of an access network device, and the second communication node is a central unit (CU) of the access network device.

In some examples, the first communication node is a user plane (UP) of a CU of an access network device, and the second communication node is a control plane (CP) of the CU of the access network device.

In the disclosure, the first communication node may establish the logical connection between the first communication node and the terminal, and send the first information to the terminal via the logical connection, such that the first information may be sent from the first communication node to the terminal.

It is understandable that the communication device 1000 may be a terminal, a device in a terminal, or a device that may be used in conjunction with a terminal.

The communication device 1600 is on a terminal side.

The transceiver module 1601 is configured to receive first information, sent by the first communication node via a logical connection.

In some examples, the transceiver module 1601 is configured to: receive a first message, sent by the first communication node via the logical connection, in which the first message is included in a PDCP SDU or a SDAP SDU.

In some examples, the transceiver module 1601 is further configured to receive a logical connection establishment request sent by the second communication node.

The processing module 1602 is configured to establish a context of the logical connection based on the logical connection establishment request.

In some examples, the transceiver module 1601 is further configured to send second information to the first communication node via the logical connection based on the context of the logical connection.

In some examples, the logical connection establishment request includes at least one of: an identifier of the logical connection; a reason for establishing the logical connection; or a quality of service (QOS) requirement of the logical connection.

In some examples, the first communication node is a DU of an access network device, and the second communication node is a CU of the access network device.

In some examples, the first communication node is a UP of a CU of an access network device, and the second communication node is a CP of the CU of the access network device.

In the disclosure, the terminal may receive the first information sent by the first communication node via the logical connection, such that the terminal may receive the first information sent by the first communication node.

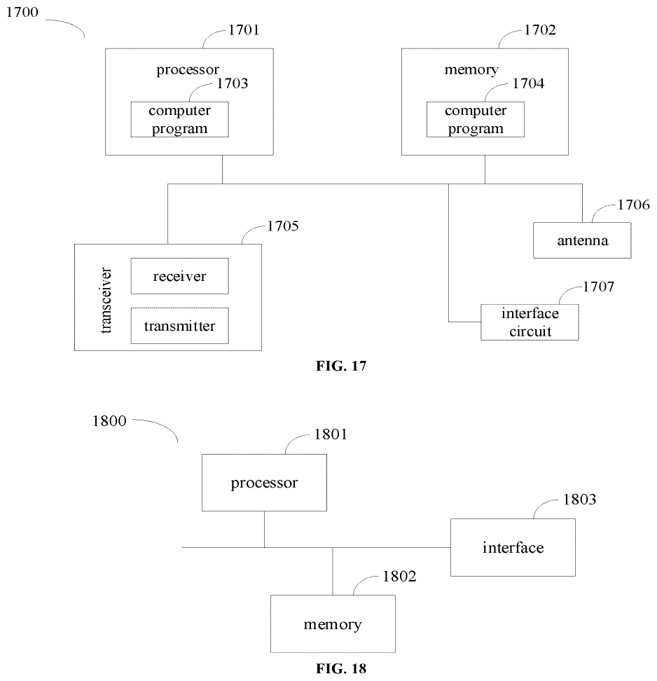

FIG. 17 is a schematic diagram illustrating a structure of another communication device according to an embodiment of the disclosure. In FIG. 17, the communication device 1700 may be a network device such as an access network device, a DU of an access network device or a CU-UP of an access network device. Or the communication device 1700 may be a terminal. Or the communication device 1700 may be a chip, a chip system or a processor that supports the network device to implement the above methods, or a chip, a chip system or a processor that supports the terminal to implement the above methods. The device may be configured to implement the methods described in the above method embodiments, and for the details, reference may be made to the description in the above method embodiments.

The communication device 1700 may include one or more processors 1701. The processor 1701 may be a general-purpose processor or a dedicated processor. For example, the processor 1701 may be a baseband processor or a central processing unit. The baseband processor may be configured to process the communication protocol and communication data. The central processing unit may be configured to control the communication device (such as a base station, a baseband chip, a terminal, a terminal chip, a DU or a CU), execute a computer program, and process the data of the computer program.

In some examples, the communication device 1700 may further include one or more memories 1702, on which a computer program 1704 may be stored. The processor 1701 is configured to execute the computer program 1704 to enable the communication device 1700 to perform the methods described in the above method embodiments. In some examples, the memory 1702 may have data stored therein. The communication device 1700 and the memory 1702 may be provided separately or integrated together.

In some examples, the communication device 1700 may further include a transceiver 1705 and an antenna 1706. The transceiver 1705 may be referred to as a transceiver unit, a transceiver machine, or a transceiver circuit, and is configured to implement a sending/receiving function. The transceiver 1705 may include a receiver and a transmitter. The receiver may be referred to as a receiver machine or a receiving circuit and is configured to implement a receiving function. The transmitter may be referred to as a transmitter machine or a transmitting circuit and is configured to implement a transmitting function.

In some examples, the communication device 1700 may further include one or more interface circuits 1707. The interface circuit 1707 is configured to receive code instructions and transmit the code instructions to the processor 1701. The processor 1701 runs the code instructions to enable the communication device 1700 to perform the methods described in the above method embodiments.

The communication device 1700 is a terminal and the processor 1701 is configured to perform step 1202 in FIG. 12 and the like.

The communication device 1700 is a network device and the transceiver 1705 is configured to perform steps 201 and 202 in FIG. 2, steps 301 and 302 in FIG. 3 and the like.

In one implementation, the processor 1701 may include a transceiver for implementing the receiving and sending functions. For example, the transceiver may be a transceiver circuit, an interface or an interface circuit. The transceiver circuit, interface or interface circuit for implementing the receiving and sending functions may be separate or integrated. The above-mentioned transceiver circuit, interface or interface circuit may be configured to read and write code/data, or the above-mentioned transceiver circuit, interface or interface circuit may be configured to transmit or deliver signals.

In one implementation, the processor 1701 may store a computer program 1703, which runs on the processor 1701 and enables the communication device 1700 to perform the methods described in the above method embodiments. The computer program 1703 may be fixed in the processor 1701, in which case the processor 1701 may be implemented by hardware.

In one implementation, the communication device 1700 may include a circuit that may implement the sending, receiving or communicating function in the aforementioned method embodiments. The processor and transceiver described in the disclosure may be implemented in an integrated circuit (IC), an analog IC, a radio frequency integrated circuit (RFIC), a mixed signal IC, an application specific integrated circuit (ASIC), a printed circuit board (PCB), an electronic device, or the like. The processor and transceiver may also be manufactured using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), or the like.

The communication device described in the above embodiments may be a network device or a terminal, but the scope of the communication device described in the disclosure is not limited thereto, and the structure of the communication device may not be limited by FIG. 17. The communication device may be an independent device or may be part of a larger device. For example, the communication device may be:
(1) a stand-alone IC, a chip, a chip system or a subsystem;
(2) a collection of ICs including one or more ICs, for example, the collection of ICs may also include a storage component for storing data and a computer program;
(3) an ASIC, such as a modem;
(4) a module that may be embedded within other devices;
(5) a receiver, a terminal, a smart terminal, a cellular phone, a wireless device, a handheld machine, a mobile unit, an in-vehicle device, a network device, a cloud device, an artificial intelligence device, and the like; and
(6) others.

For the case where the communication device may be a chip or a chip system, the schematic diagram of a structure of the chip is illustrated in FIG. 18. The chip 1800 illustrated in FIG. 18 includes a processor 1801 and an interface 1803. The number of processors 1801 may be one or more, and the number of interfaces 1803 may be multiple.

For the case where the chip is configured to implement the functions of the terminal in the embodiments of the disclosure, the interface 1803 is configured to execute step 1101 in FIG. 11; step 1201 and step 1203 in FIG. 12, or the like.

For the case where the chip is configured to implement the functions of the network device in the embodiments of the disclosure, the interface 1803 is configured to execute step 201 and step 202 in FIG. 2; step 301 and step 302 in FIG. 3, or the like.

In some examples, the chip 1800 further includes a memory 1802, and the memory 1802 is configured to store necessary computer programs and data.

Those skilled in the art may also understand that the various illustrative logical blocks and steps listed in the embodiments of the disclosure may be implemented by electronic hardware, computer software, or a combination thereof. Whether such functions are implemented by hardware or software depends on the specific application and the design requirements of the entire system. Those skilled in the art may use various methods to implement the functions described for each specific application, but such implementation should not be understood as exceeding the scope of protection of the embodiments of the disclosure.

The disclosure also provides a readable storage medium having instructions stored thereon. When the instructions are executed by a processor, the functions of any of the above-mentioned method embodiments are implemented.

The disclosure also provides a computer program product. When the computer program product is executed by a computer, the functions of any of the above method embodiments are implemented.

The above embodiments may be implemented entirely or in part by software, hardware, firmware or any combination thereof. When implemented by software, the embodiments may be implemented entirely or in part in the form of a computer program product. The computer program product includes one or more computer programs. When the computer programs are loaded and executed on a computer, the process or function described in the embodiments of the disclosure is generated in whole or in part. The computer may be a general-purpose computer, a special-purpose computer, a computer network, or other programmable device. The computer program may be stored in a computer-readable storage medium, or transmitted from one computer-readable storage medium to another computer-readable storage medium. For example, the computer program may be transmitted from a website site, computer, server or data center by wired (e.g., coaxial cable, optical fiber, digital subscriber line (DSL)) or wireless (e.g., infrared, wireless, microwave, etc.) mode to another website site, computer, server or data center. The computer-readable storage medium may be any available medium that may be accessed by a computer or a data storage device, such as a server or data center, that includes one or more available media integrated. The available medium may be a magnetic medium (e.g., a floppy disk, a hard disk, a magnetic tape), an optical medium (e.g., a high-density digital video disc (DVD)), or a semiconductor medium (e.g., a solid state disk (SSD)).

Those skilled in the art may understand that the various numerical numbers, such as “first” and “second”, involved in the disclosure are only used for the convenience of description and are not used to limit the scope of the embodiments of the disclosure, and also indicate the order of precedence.

The term “at least one” in the disclosure may also be described as “one or more”, and the term “a plurality of” may be “two,” “three,” “four” or more, which is not limited in the disclosure. In the embodiments of the disclosure, for a kind of technical features, technical features of the same kind are distinguished by “first”, “second”, “third”, “A”, “B”, “C” and “D”, and there is no order of precedence or size between the technical features described by the “first”, “second”, “third”, “A”, “B”, “C” and “D”.

The correspondence shown in the tables in the disclosure may be configured or may be predefined. The values of information in the tables are merely examples and may be set to other values, which are not limited in the disclosure. In configuring the correspondence between the information and the parameters, there does not require that all the correspondences illustrated in the tables must be configured. As an example, the correspondences on some rows of the table in the disclosure may not be configured. As another example, the above tables may be adjusted appropriately, such as being split, being merged, and the like. The names of the parameters illustrated in the headings of the above tables may be other names that are understood by the communication device, and the values or representations of the parameters may be other values or expressions that are understood by the communication device. Each of the above tables may also be implemented with other data structures, such as arrays, queues, containers, stacks, linear tables, pointers, chained lists, trees, graphs, structures, classes, heaps, and hash tables.

1. A method for sending information, performed by a first communication node, the method comprising:
receiving delivery-related information of first information sent by a second communication node, wherein the second communication node has sent a first part of the first information to a terminal; and
sending the first information to the terminal based on the delivery-related information.

2. The method of claim 1, wherein sending the first information to the terminal based on the delivery-related information comprises one of:
receiving a second part of the first information sent by the second communication node; and
sending the second part to the terminal via a first message based on information for indicating the first part in the delivery-related information;
acquiring the first information based on at least one of an identifier of the first information or storage node information of the first information in the delivery-related information; determining a second part based on information for indicating the first part in the delivery-related information; and sending the second part to the terminal via a first message based on the information for indicating the first part; or
acquiring the first information based on at least one of an identifier of the first information or storage node information of the first information in the delivery-related information; and sending the first information to the terminal via a first message.

4. The method of claim wherein the information for indicating the first part comprises at least one of:
segmentation information of the first information;
a segment number of a segmented message of the first part;
a segment number of a segmented message confirmed to have been received by the terminal;
a recommended segment number of the second part; or
a percentage of the first part in the first information.

5. (canceled)

6. The method of claim 2, wherein the first message is sent in segments.

7. The method of claim 2, wherein the first message is any one of:
a radio resource control (RRC) message;
a non-access stratum (NAS) message; or
a newly defined protocol message.

8. The method of claim 1, wherein receiving the delivery-related information of the first information sent by the second communication node comprises:
receiving a signaling forwarding request sent by the second communication node;
in a case of determining to accept signaling forwarding based on the signaling forwarding request, sending signaling forwarding accepted information to the second communication node; and
receiving the delivery-related information, sent by the second communication node based on the signaling forwarding accepted information.

9. A method for sending information, performed by a first communication node, the method comprising:
establishing a logical connection between the first communication node and a terminal; and
sending first information to the terminal via the logical connection.

10. The method of claim 9, wherein the first communication node is an access network device, a second communication node is a core network device, and establishing the logical connection between the first communication node and the terminal comprises:
sending a protocol data unit (PDU) session establishment request to the second communication node;
receiving PDU session establishment indication information, sent by the second communication node based on the PDU session establishment request, wherein the PDU session establishment indication information comprises indication information for indicating that a PDU session to be established is used to send the first information; and
establishing the logical connection and the PDU session corresponding to the logical connection between the first communication node and the terminal based on the PDU session establishment indication information.

11. The method of claim 10, wherein the PDU session establishment request comprises at least one of:
a PDU session request indication;
a quality of service (QOS) requirement of the PDU session;
a duration of the PDU session;
an identifier of the first information; or
a data size of the first information.

12. The method of claim 10, wherein sending the first information to the terminal via the logical connection comprises:
sending the first message to the terminal via the logical connection, wherein the first message is comprised in a packet data convergence protocol service data unit (PDCP SDU) or a service data adaptation protocol service data unit (SDAP SDU).
wherein the PDCP SDU or the SDAP SDU further comprises auxiliary information, wherein the auxiliary information is used for instructing the terminal to receive and process the first information.

13. (canceled)

14. The method of claim 9, wherein establishing the logical connection between the first communication node and the terminal comprises:
receiving a logical connection establishment request sent by a second communication node; and
establishing the logical connection based on the logical connection establishment request.

15. The method of claim 14, wherein establishing the logical connection based on the logical connection establishment request comprises one of:
in a case where the logical connection establishment request is not comprised in PDU session establishment list information, establishing the logical connection based on the logical connection establishment request, wherein the logical connection has no corresponding PDU session; or
in a case where the logical connection establishment request is comprised in PDU session establishment list information, establishing the logical connection based on the logical connection establishment request, wherein the logical connection establishment request comprises dummy PDU session indication information, and the logical connection corresponds to a dummy PDU session.

16. (canceled)

17. The method of claim 14, wherein the first information is sent by the second communication node to the first communication node,
wherein the method further comprises: receiving second information, sent by the terminal via the logical connection, and
wherein the logical connection establishment request comprises at least one of: an identifier of the logical connection; a reason for establishing the logical connection; or a quality of service (QoS) requirement of the logical connection.

18-19. (canceled)

20. The method of claim 14, wherein the first communication node is a distributed unit (DU) of an access network device, and the second communication node is a central unit (CU) of the access network device, or
wherein the first communication node is a user plane (UP) of a central unit (CU) of an access network device, and the second communication node is a control plane (CP) of the CU of the access network device.

21. (canceled)

22. A method for sending information, performed by a terminal, the method comprising:
receiving first information, sent by a first communication node via a logical connection.

23. The method of claim 22, wherein receiving the first information, sent by the first communication node via the logical connection comprises:
receiving a first message, sent by the first communication node via the logical connection, wherein the first message is comprised in a packet data convergence protocol service data unit (PDCP SDU) or a service data adaptation protocol service data unit (SDAP SDU).

24. The method of claim 22, further comprising:
receiving a logical connection establishment request sent by a second communication node; and
establishing a context of the logical connection based on the logical connection establishment request.

25. The method of claim 24, further comprising:
sending second information to the first communication node via the logical connection based on the context of the logical connection.
wherein the logical connection establishment request comprises at least one of: an identifier of the logical connection; a reason for establishing the logical connection; or a quality of service (QOS) requirement of the logical connection.

26. (canceled)

27. The method of claim 24, wherein the first communication node is a distributed unit (DU) of an access network device, and the second communication node is a central unit (CU) of the access network device,
wherein the first communication node is a user plane (UP) of a central unit (CU) of an access network device, and the second communication node is a control plane (CP) of the CU of the access network device.

28-31. (canceled)

32. A communication device, comprising a processor and a memory, wherein the memory has a computer program stored therein, and the processor is configured to execute the computer program stored in the memory to enable the communication device to perform the method of claim 1.

33. (canceled)
